(19) United States
(12) Patent Application Publication
(10) Pub. No.: US 2004/0119850 A1
(43) Pub. Date: Jun. 24, 2004

(54) Method and camera for capturing a composite picture

(75) Inventor: Robert Francis Squibbs, Bristol (GB)

Correspondence Address: HEWLETT-PACKARD COMPANY, Intellectual Property Administration, P.O. Box 272400, Fort Collins, CO, 80527-2400, US

(73) Assignee: HEWLETT-PACKARD DEVELOPMENT COMPANY, L.P.

(21) Appl. No.: 10/678,210

(22) Filed: Oct. 2, 2003

(30) Foreign Application Priority Data
Dec. 24, 2002 (GB) 0230109.1

(51) Int. Cl. H04N 5/262

(52) U.S. Cl. 348/239

(57) ABSTRACT

A camera is provided for taking a combined picture by combining an optically-input image with an electronically-downloaded image. The composition of the combined picture is controlled both by adjusting the direction of pointing of the camera to control the content of the optically-input image and by electronically controlling the positioning and/or size of the downloaded image.

### FIELD OF THE INVENTION

The present invention relates to a method and camera for taking a picture composed from two images.

### BACKGROUND OF THE INVENTION

It is well known to provide for images to be combined to form a final picture and the ability to do so has become much more widespread in recent times with the advent of digital photography and image-editing programs running on home computers. Even so, the average user of a camera does not want to concern themselves with such technicalities.

It is an object of the present invention to provide a simple way of taking pictures that combine images.

### SUMMARY OF THE INVENTION

According to one aspect of the present invention, there is provided a camera comprising:

a first subsystem for electronically downloading, from externally of the camera, first digital image data representing a first image;

a second subsystem for converting an optically-input second image into second digital image data which changes as the scene pointed to by the camera changes;

an image-combining arrangement for forming a combined picture by combining the images represented by the first image data and the current second image data, the image-combining arrangement including a display for viewing the combined picture and user-operable first-image control means for electronically controlling the positioning and/or size of the first image in the combined picture; and

a picture storage arrangement responsive to user input to store said combined picture.

In forming the desired combined picture, the user can thus control both the electronically-downloaded first image and the optically-input second image, the first image being controlled electronically whilst the second image is controlled by adjusting the direction of pointing of the camera.

According to another aspect of the present invention, there is provided a method of capturing a composite picture using a camera, comprising:

electronically downloading to the camera first digital image data representing a first image;

converting an optically-input second image into second digital image data which changes as the scene pointed to by the camera changes;

forming a combined picture at the camera by combining the images represented by the first image data and the current second image data, the combined picture being displayed and its composition being controlled both by changing the direction of the camera to change the second image and by electronically controlling the positioning and/or size of the first image in the combined picture; and

storing said combined picture.

### BRIEF DESCRIPTION OF THE DRAWINGS

Embodiments of the invention will now be described, by way of non-limiting example, with reference to the accompanying diagrammatic drawings, in which:

FIG. 1 is a diagram showing a camera being used to take a photograph of a memorial with the inclusion of an historical image of a person commemorated by the memorial; and

FIG. 2 is a functional block diagram of the FIG. 1 camera.

### BEST MODE OF CARRYING OUT THE INVENTION

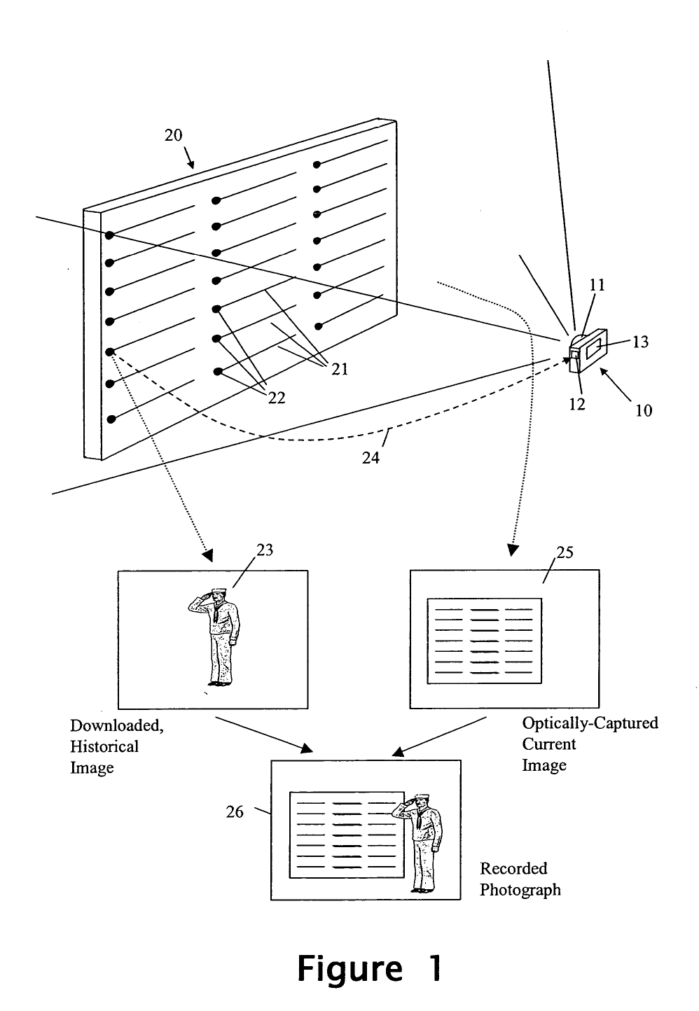

FIG. 1 depicts a hand-held camera 10 embodying the present invention. The camera 10 is being used to take a photograph of a war memorial 20 on which are listed the names 21 of service men and woman commemorated by the memorial.

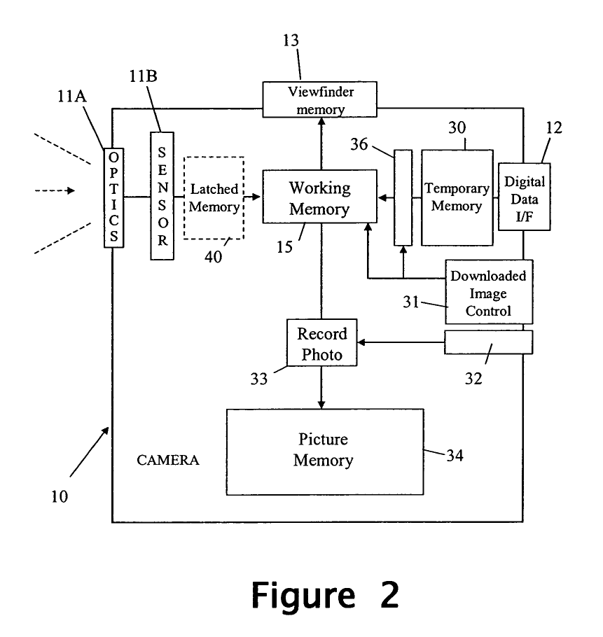

The camera 10 comprises an optical image-capture system 11 including a lens arrangement 11A (see FIG. 2) and a photoelectrical sensor 11B that may be of any suitable form such as a CCD array. The image captured by the sensor 11B is temporarily stored in a working memory 15 and is from there displayed to a user of the camera on viewfinder display 13. The memory 15 is preferably separate from the sensor array 11B but is updated regularly from the latter (for example 24 times a second).

In addition to the optical image-capture system 11, the camera 10 also comprises an interface 12 for receiving digital data signals representing a previously-stored, historical image—in this case an image 23 of any selected one of the commemorated persons. More particularly, in the present example, alongside the name 21 of each commemorated person on the memorial 20, is embedded an inductively-powered memory module 22 that stores, as digital data, an image of the person concerned. In order to download the image data held in a module 22, the camera 10 is brought up close to the memory module 22 such that the camera's interface 12 is juxtaposed the module resulting in the latter being inductively powered up. Upon this happening, the memory module is arranged to transmit its stored data by very short-range wireless signals to a wireless pickup incorporated in the interface 12. Memory modules of this form are known in the art and module 22 and interface 12 will therefore not be described in further detail herein.

The image data downloaded through interface 12 is held in a temporary memory 30 of the camera from where it is copied to the working memory 15 and, as a result, is displayed on viewfinder display 13. Transfer of the image data to the memory 15 is preferably, though not necessarily, done automatically upon downloading of the image data on the assumption that the image concerned is for immediate use.

It will be appreciated that in the present embodiment the interface 12 needs to be placed right up close to the selected memory module 22 in order to download data from the module to the camera 10. This has two consequences, the first being that selection of the memory module 22 to be activated is simply a matter of bringing the interface 12 right up close to the module it is desired to read. The second consequence is that the user cannot pick up image data from a memory module 12 whilst positioned to take a picture of the memorial 10.

The optically-input image 25 is used to form a background behind the downloaded personimage 23 whereby the user sees in the viewfinder display 13 a combined image of the form illustrated at 26 in FIG. 1. To this end, each time the image captured by the sensor 11B is transferred to memory 15, it is not written into memory locations of the memory 15 that hold downloaded-image data from memory 30; this can be achieved by using one bit of the multi-bit data held in each memory location as a flag bit to indicate whether the data currently stored in the location is downloaded data (for example, the bit is set if the stored data is downloaded data). Before data is written into a memory location from the sensor 11B, the flag bit of that location is checked and the location is only written to if the flag bit indicates that the location does not contain downloaded image data.

It can be seen that the working memory 15 forms the basis of an image-combining arrangement for combining the optically captured image and the downloaded imaged.

The user can record the combined image by pressing a “shutter” control 32 that causes a control block 33 to store a digital copy of the image seen in viewfinder display 13 in a long-term picture memory 34 of the camera.

The contents of the optically-input image 25 forming the background in the combined image are dependent on what scene the camera is pointing at and the optical settings of the lens arrangement 11A. This image is thus under the control of the user; because the memory 15 is updated multiple times a second from the sensor 11B, any change in what the user is pointing the camera at is immediately reflected in the contents of the memory 15 and the image seen on viewfinder display 13.

The user can also incrementally (that is, in very small steps such as pixel sized steps) control the size and placement in the combined image 26 of the downloaded person-image 23 by means of controls 31 that cause a transfer block 36 to set the scaling and position of the image 23 as it is copied from memory 30 to memory 15. Whenever the position or size 30 of the image 23 is changed using the controls 31, before writing the image anew into the memory 15 the block 36 first erases the contents of memory 15; thereafter, block 36 writes the image 23 in its new position/size into memory 15 with the flag bit of the locations written to being set to indicate that those locations are not to be overwritten by the optically-input image data. It will be appreciated that the image 23 is taken not to be present where there is no significant visually-discernible feature indicated by the image data (thus, for example, a blank or white or black background will be ignored).

The user can thus control both the optically-input and electronically-downloaded image in forming the desired combined picture, this control being effected with the minimum of trouble and without the use of complex editing equipment.

After a combined picture has been recorded by operation of control 32, the temporary memory 30 and the working memory 15 can be cleared—or, indeed, left unchanged pending a new image being downloaded via interface 12.

It will be appreciated that many variants are possible to the above described embodiments of the invention. Thus, the optically-input image could be latched into an intermediate memory (see latch memory 40 shown dashed in FIG. 2) at, for example, the same time as a first combined picture is recorded using the control 32, the memory 15 then being refreshed regularly from memory 40 in the manner already described for refreshes from the sensor 11B. Such an arrangement permits the same background image to be used in several combined pictures each of which may include a different downloaded image.

The above-described arrangement for combining the optically-input image and the downloaded image is unsophisticated and relies on the downloaded image being of a form suitable to overlay a background image. More sophisticated image-combining arrangements, known per se, can be used to merge the optically-input and downloaded images.

Furthermore, the downloaded image need not necessarily form a foreground image and could, instead, be used as a background image for an optically-input image, the latter now serving as a foreground image.

With regard to how the electronically-downloaded image is received by the camera 10, it will be appreciated that the described memory module arrangement is but one example of many possible ways of downloading a relevant image. For example, images can be downloaded from contact-based memory cards used as local image stores. Alternatively, a short-range radio system, such as a Bluetooth system, can be used to transfer image data to the camera. In this latter case, where the local density of images for download is low, then a single image can be associated with each short-range wireless system. However, where a short-range wireless system is to be used as the download arrangement for more than one image, then it will be necessary to provide a way of indicating the desired image to the download wireless transmitter; this can be done, for example, by selection buttons on the camera to provide input (via the short-range wireless system) to the image transmitter, or by the provision of buttons directly connected to the image transmitter system itself. Of course, it is also possible to provide for the camera to receive multiple downloaded images, image selection then being done at the camera by discarding unwanted images.

Other arrangements for downloading images include providing a central or distributed image store from which an image can be downloaded via a wireless LAN or cellular mobile link, the desired image being indicated to the store using a locally-captured image reference or locality indicator (in this latter respect, the current location of the camera as indicated by any suitable system—such as a GPS system, a PLMN-based system, a location-beacon system etc—can be used to retrieve images relevant to the camera's current location).

Generally, the camera 10 is intended to enable a user to record a picture that is a combination of a current image captured through the optical system of the camera, and an historical (that is, a stored and not current) electronically-downloaded image that is related in some way to the optically-input image. The relationship may be person to place as in the FIG. 1 example or some other relationship. Another example combination is where the user visits a battlefield and a relevant downloaded battle map is combined with the current view of the battlefield; a more general example is that of the downloaded image showing an earlier view of the optically-input image (for example, an old image of a church is combined in side-by-side relation with a current optically-input view of the church).

In fact, the downloaded image need not be an historical image but could be a current image taken from an infrastructure camera—for example, on visiting the Kennedy Space Center, a user could be enabled to download a current close-up image of a space shuttle being prepared for launch, this image being combined with the optically-input image of a person, (the person image being used as a foreground image and the space-shuttle image as background).

Whilst in the preferred embodiments the capturing of the optically-input and electronically downloaded images and the forming and recording of a combined picture are all effected substantially at the same time with it being necessary to finish one combined picture before another is initiated, it is also possible to store, for later combination, the optically-input image and the electronically-downloaded image. In this case, the stored images are marked or stored in such a way to indicate their association whereby to facilitate subsequent retrieval and combination preferably in the camera, though possibly off camera (for example in a PC equipped with suitable editing software). Provision is preferably made for storing multiple sets of associated first and second images.

In another variant, the electronically downloaded data rather than being image data, or only image data, comprises audio data to be associated with the optically-input image. Thus a commentary about a place being visited can be recorded along with the user's own picture of the place.

Although the above-described embodiments concern still images, it will be appreciated the same approach can be applied for combining, in camera, optically-input and electronically downloaded moving images.

1. A camera comprising:
a first subsystem for electronically downloading, from externally of the camera, first digital image data representing a first image;
a second subsystem for converting an optically-input second image into second digital image data which changes as the scene pointed to by the camera changes;
an image-combining arrangement for forming a combined picture by combining the images represented by the first image data and the current second image data, the image-combining arrangement including a display for viewing the combined picture and user-operable first-image control means for electronically controlling the positioning and/or size of the first image in the combined picture; and
a picture storage arrangement responsive to user input to store said combined picture.

2. A camera according to claim 1, wherein the first-image control means is arranged to incrementally control the positioning of the first image in the combined picture.

3. A camera according to claim 1, wherein the first subsystem is arranged to store said first image data on a temporary basis with currently-stored first image data being replaced by any new first image data downloaded to the camera.

4. A camera according to claim 1, wherein the image-combining arrangement is arranged to place the first image in foreground relation with the second image.

5. A camera according to claim 1, wherein the image-combining arrangement is arranged to place the first image in background relation with the second image.

6. A camera according to claim 1, wherein the first subsystem comprises an interface for reading the first image data from a memory module installed in the environment.

7. A camera according to claim 1, wherein the first subsystem comprises means for reading a reference stored in the local environment and for using the reference to wirelessly retrieve said first image data.

8. A camera according to claim 1, wherein the first subsystem comprises means for deriving the location of the camera and for using this location to wirelessly retrieve said first image data.

9. A method of capturing a composite picture using a camera, comprising:
electronically downloading to the camera first digital image data representing a first image;
converting an optically-input second image into second digital image data which changes as the scene pointed to by the camera changes;
forming a combined picture at the camera by combining the images represented by the first image data and the current second image data, the combined picture being displayed and its composition being controlled both by changing the direction of the camera to change the second image and by electronically controlling the positioning and/or size of the first image in the combined picture; and
storing said combined picture.

10. A method according to claim 9, wherein in the combined picture the first image is placed in foreground relation with the second image.

11. A method according to claim 9, wherein in the combined picture the first image is placed in background relation with the second image.

12. A method according to claim 9, wherein the first image data is downloaded from a memory module installed in the environment.

13. A method according to claim 9, wherein the first image data is downloaded over a wireless connection using an image reference read from the local environment.

14. A method according to claim 9, wherein the location of the camera is determined and used as a reference for retrieving the first image data over a wireless connection.
